(19) United States
(12) Patent Application Publication
(10) Pub. No.: US 2017/0108180 A1
(43) Pub. Date: Apr. 20, 2017

(54) LAMP TUBE AND LAMP DEVICE WITH ADJUSTABLE COLOR TEMPERATURE

(71) Applicant: Ching-Chuan LEE, New Taipei City (TW)

(72) Inventor: Ching-Chuan LEE, New Taipei City (TW)

(21) Appl. No.: 14/887,967

(22) Filed: Oct. 20, 2015

(51) Int. Cl. F21K 99/00; F21V 29/89; F21V 29/70

(52) U.S. Cl. CPC F21K 9/58; F21K 9/175; F21V 29/70; F21V 29/89; F21Y 2101/02; F21Y 2103/003

(57) ABSTRACT

A lamp tube with adjustable color temperature includes: a top housing, having the top end formed with a notch; a bottom housing, formed with a first recess and a second recess; a slide device, exposed at the notch and capable of sliding in the second recess; a light source module, disposed with a plurality of LED chips; a light filtering module, disposed with a plurality of light filtering sheets; and two end covers; when the slide device slides to a first location, the LED chips are enabled to emit lights with a first color temperature through the light filtering sheets; and when the slide device slides to a second location, the LED chips are enabled to emit lights with a second color temperature, thereby achieving an objective of adjusting the color temperature of the lamp tube. In addition, a lamp device with adjustable color temperature is also disclosed.

### BACKGROUND OF THE INVENTION

1. Field of the Invention

The present invention relates to a lamp tube and a lamp device with adjustable color temperature, especially to a lamp tube and a lamp device with adjustable color temperature in which a slide device is able to drive light filtering sheets to proper locations by applying an external force for enabling LED chips to emit lights with a desired color temperature through the light filtering sheets.

2. Description of Related Art

The lighting provided to vegetables or meats or other objects is often supplied by utilizing a conventional fluorescent lamp tube. For the purpose of saving energy, elongated LED lamp tubes are utilized in many shopping places for providing lighting to vegetables or meats or other objects. However, there is only a limited amount of color temperatures available for both of the conventional fluorescent lamp tube and the elongated LED lamp tube, and there is no proper lighting specially designed for vegetables or meats or other objects, so the vegetables or meats or other objects are not enabled to present their natural colors, so consumers cannot easily tell the freshness thereof.

There is an elongated LED lamp tube with adjustable color temperature available in the market, and a LED light source with two color temperatures is installed inside the elongated LED lamp tube, the brightness of the LED light source is controlled by an electronic circuit for achieving an objective of adjusting color temperature, so the vegetables or meats or other objects are enabled to present better natural colors. However, in the above-mentioned elongated LED lamp tube with adjustable color temperature, an electronic circuit has to be additionally installed for controlling the color temperature adjustment of the LED light source, so the production cost is relatively higher, and the means for adjusting color temperature is not convenient for users.

As such, how to design a novel lamp tube with adjustable color temperature for overcoming the above-mentioned disadvantages shall be seriously concerned by the skilled people in the art.

### SUMMARY OF THE INVENTION

One primary objective of the present invention is to provide a lamp tube with adjustable color temperature, which includes a slide device and a light filtering module; when the slide device slides to a first location, plural LED chips are enabled to emit lights with a first color temperature through plural light filtering sheets; when the slide device slides to a second location, the LED chips are enabled to emit lights with a second color temperature, thereby achieving an objective of adjusting the color temperature of the lamp tube.

For achieving said objective, the present invention provides a lamp tube with adjustable color temperature, which includes: a top housing, formed in a hollow status, wherein the top end thereof is formed with a notch; a bottom housing, disposed with a substrate, wherein the bottom end of the substrate is formed with a hollow chamber, two sides of the substrate and the bottom housing are respectively formed with a first recess, the top end of each of the first recesses is formed with a second recess, and the outer sides defined at two ends of the bottom housing are respectively formed with a third recess for being combined with the top housing; a slide device, including a main body and a sliding member, wherein the sliding member is exposed at the notch, two ends of the main body are respectively received in the second recesses, and the main body is able to slide in the second recesses; a light source module, disposed on the substrate and having two ends thereof received in the first recesses, wherein a plurality of LED chips are disposed on the light source module; a light filtering module, disposed on top of the light source module, fastened at one side of the main body, and having two ends thereof fastened in the second recesses, wherein a plurality of light filtering sheets are disposed on the light filtering module; and two end covers, respectively covered at two ends of the top housing and the bottom housing; when the sliding member slides to a first location, the LED chips are enabled to emit lights with a first color temperature through the light filtering sheets; and when the sliding member slides to a second location, the LED chips are enabled to emit lights with a second color temperature, thereby achieving the objective of adjusting the color temperature of the lamp tube.

For achieving said objective, the present invention provides a lamp device with adjustable color temperature, which includes: a top housing, having the top end formed with a notch; a bottom housing, disposed with a substrate, wherein the bottom end of the substrate is formed with a hollow chamber, two sides of the substrate are respectively formed with a first recess, the top end of each of the first recesses is formed with a second recess, and the outer sides defined at two ends of the bottom housing are respectively formed with a third recess for being combined with the top housing; a slide device, including a main body and a sliding member, wherein the sliding member is exposed at the notch, two ends of the main body are respectively received in the second recesses, and the main body is able to slide in the second recesses; a light source module, disposed on the substrate and having two ends thereof received in the first recesses, wherein a plurality of LED chips are disposed on the light source module; a light filtering module, disposed on top of the light source module, fastened at one side of the main body, and having two ends thereof fastened in the second recesses, wherein a plurality of light filtering sheets are disposed on the light filtering module; and two end covers, respectively covered at two ends of the top housing and the bottom housing; when the sliding member slides to a first location, the LED chips are enabled to emit lights with a first color temperature; and when the sliding member slides to a second location, the LED chips are enabled to emit lights with a second color temperature, thereby achieving the objective of adjusting the color temperature of the lamp device.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view illustrating the lamp tube with adjustable color temperature according to one preferred embodiment of the present invention;

FIG. 2 is a schematic view illustrating the assembly of the lamp tube with adjustable color temperature according to one preferred embodiment of the present invention;

FIG. 3 is a partial perspective view illustrating the slide device sliding to a first location for enabling the light source module to emit lights with a first color temperature according to one preferred embodiment of the present invention;

FIG. 4 is a partial perspective view illustrating the slide device sliding to a second location for enabling the light source module to emit lights with a second color temperature according to one preferred embodiment of the present invention;

FIG. 5 is an exploded view illustrating the lamp tube with adjustable color temperature according to another preferred embodiment of the present invention; and

FIG. 6 is a schematic view illustrating the assembly of the lamp tube with adjustable color temperature according to another preferred embodiment of the present invention.

### DETAILED DESCRIPTION OF THE PREFERRED EMBODIMENT

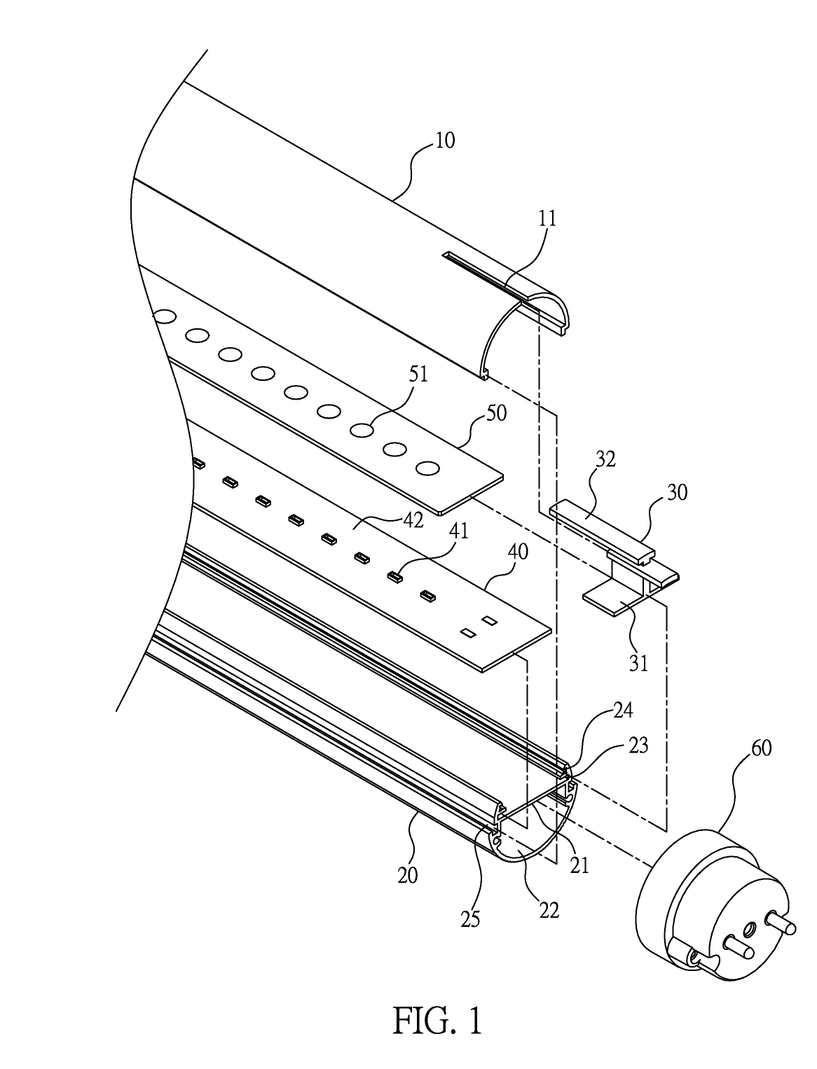

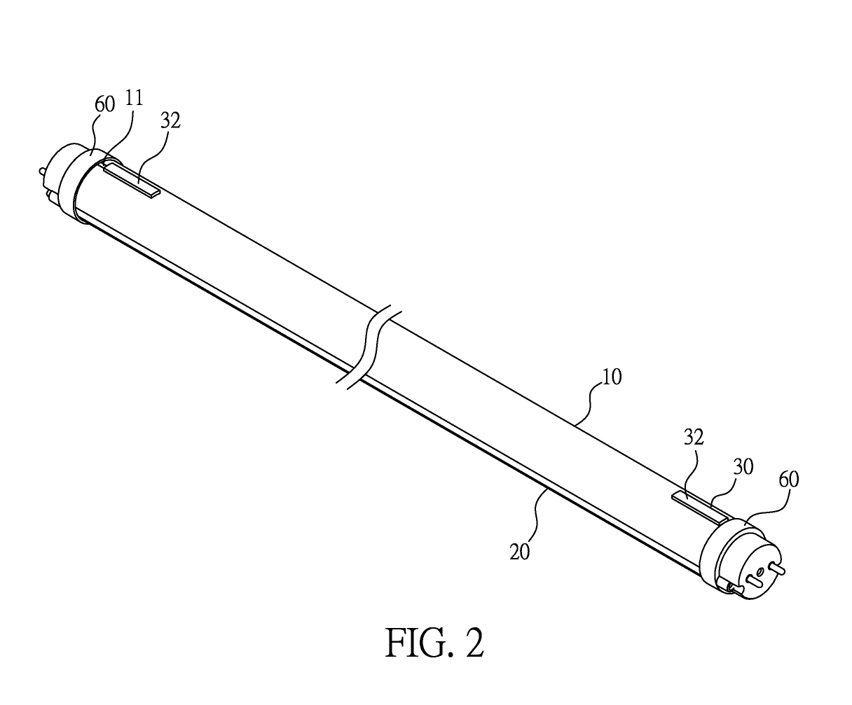

Referring from FIG. 1 and FIG. 2, wherein FIG. 1 is an exploded view illustrating the lamp tube with adjustable color temperature according to one preferred embodiment of the present invention; and FIG. 2 is a schematic view illustrating the assembly of the lamp tube with adjustable color temperature according to one preferred embodiment of the present invention.

As shown in figures, the present invention provides a lamp tube with adjustable color temperature, which includes: a top housing 10, a bottom housing 20, a slide device 30, a light source module 40, a light filtering module 50 and two end covers 60.

The top housing 10 is formed as a hollow tubular member and the top end thereof is formed with a notch 11. Wherein, the top housing 10 is a transparent or translucent housing and made of, e.g. but not limited to, glass, acrylic or plastic.

The bottom housing 20 is disposed with a substrate 21. The bottom end of the substrate 21 is formed with a hollow chamber 22. Two sides of substrate 21 and the bottom housing 20 are respectively formed with a first recess 23, the top end of each of the first recesses 23 is formed with a second recess 24, and the outer sides defined at two ends of the bottom housing 20 are respectively formed with a third recess 25 for being combined with the top housing 10. Wherein, the third recesses 25 are, e.g. but not limited to be, disposed below the substrate 21.

The slide device 30 includes a main body 31 and a sliding member 32. The sliding member 32 is exposed at the notch 11. Two ends of the main body 31 are respectively received in the second recesses 24, and the main body 31 is able to slide in the second recesses 24. Wherein, the slide device 30 is, e.g. but not limited to be, made of plastic.

According to this embodiment, two slide devices 30 are adopted for illustration and respectively disposed at two ends of the top housing 10, what shall be addressed is that the scope of the present invention is not limited to the above-mentioned arrangement. If only one slide device 30 is adopted, the slide device 30 is disposed at one end of the top housing 10 and the objective of adjusting color temperature can also be achieved.

The light source module 40 is disposed on the substrate 21, and two ends thereof are respectively fastened in the first recesses 23. A plurality of LED chips 41 are disposed on the light source module 40. Wherein, the light source module 40 further includes a printed circuit board 42, and the printed circuit board 42 is used for carrying the plural LED chips 41. The printed circuit board 42 further includes a plurality of LED driving chips (not shown in figures), and the plural LED driving chips are respectively coupled to the plural LED chips 41 for driving the LED chips 41. Wherein, the printed circuit board 42 is, e.g. but not limited to, an aluminum substrate or a copper substrate for enhancing the heat dissipation performance.

The light filtering module 50 is disposed on top of the light source module 40 and fastened at one side of the main body 31, e.g. but not limited to the left side. Two ends of the light filtering module 50 are respectively fastened in the second recesses 24. The light filtering module 50 is disposed with a plurality of light filtering sheets 51, and the quantity of the light filtering sheets 51 is preferably to be the same as the quantity of the LED chips 41. Wherein, the plural light filtering sheets 51 are formed with a, e.g. but not limited to, coating or printing means, and the shapes thereof are formed in a, e.g. but not limited to, circular or semi-circular shape; according to this embodiment, the circular shape is adopted for illustration, what shall be addressed is that the scope of the present invention is not limited to the above-mentioned arrangement.

The two end covers 60 are respectively covered at two ends of the top housing 10 and the bottom housing 20.

In addition, the lamp tube with adjustable color temperature provided by the present invention further includes a power module (not shown in figures) disposed in the hollow chamber 22, one end thereof is coupled to the end cover 60, the end cover 60 is coupled to an AC power source (not shown in figures), the other end thereof is coupled to the light source module 40 for supplying the electric power required by the light source module 40.

As shown in FIG. 2, when being assembled, the light source module 40 is inserted in the first recesses 23 from the outer side of the bottom housing 20; the light filtering module 50 is combined with the main body 31 of the slide device 30, and two sides of the light filtering module 50 and the main body 31 are inserted in the second recesses 24 from the outer side of the bottom housing 20; then the third recesses 25 are utilizing for enabling the top housing 10 to be engaged with the bottom housing 20, meanwhile the sliding member 32 is exposed at the notch 11 of the top housing 10, so the slide device 30 is able to slide in the second recesses 24; lastly the two end covers 60 are respectively covered at two ends of the top housing 10 and the bottom housing 20. Accordingly, the assembly of the lamp tube with adjustable color temperature is assembled.

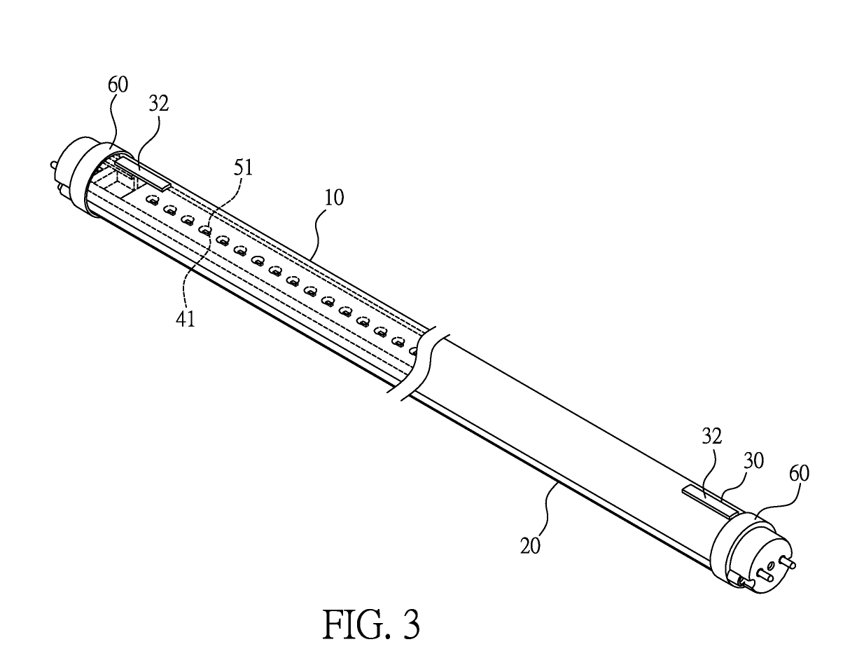

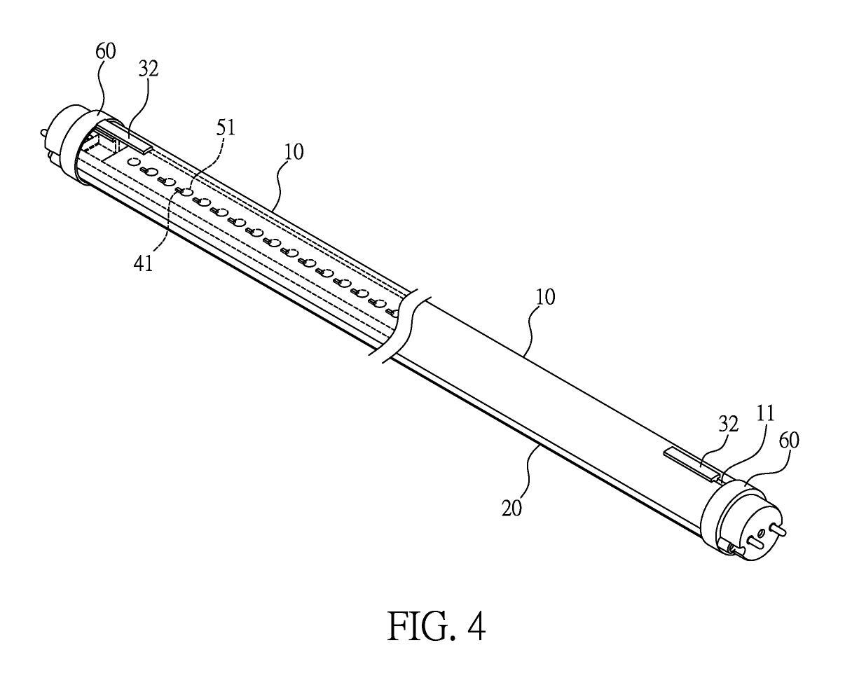

Referring to FIG. 3 and FIG. 4, wherein FIG. 3 is a partial perspective view illustrating the slide device sliding to a first location for enabling the light source module to emit lights with a first color temperature according to one preferred embodiment of the present invention; and FIG. 4 is a partial perspective view illustrating the slide device sliding to a second location for enabling the light source module to emit lights with a second color temperature according to one preferred embodiment of the present invention.

As shown in FIG. 3, when the sliding member 32 of the slide device 30 slides to a first location, the plural light filtering sheets 51 are respectively disposed on top of the plural LED chips 41, so the plural LED chips 41 are enabled to emit lights with a first color temperature through the plural light filtering sheets 51.

As shown in FIG. 4, when the sliding member 32 of the slide device 30 slides to a second location, the plural light filtering sheets 51 are respectively disposed at one side of each of the LED chips 41, so the plural LED chips 41 are enabled to emit lights with a second color temperature, wherein the lights with the second color temperature are the original lights of the LED chips 41. As such, the lamp tube with adjustable color temperature provided by the present invention is able to output lights with different color temperature for enabling vegetables or meats or other objects to present better natural colors, so the consumers can easily tell the freshness thereof.

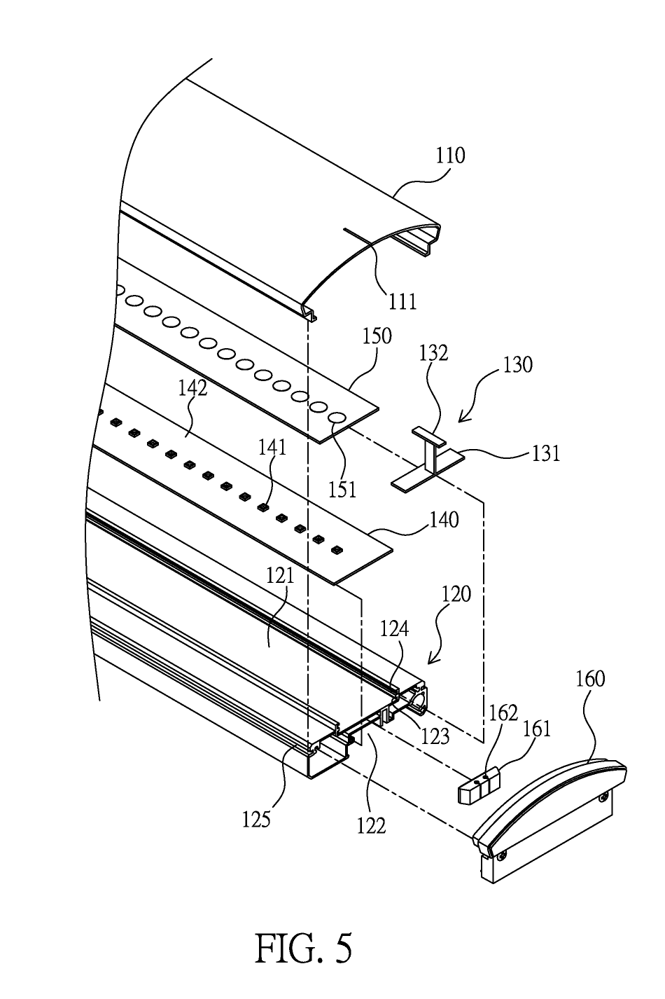

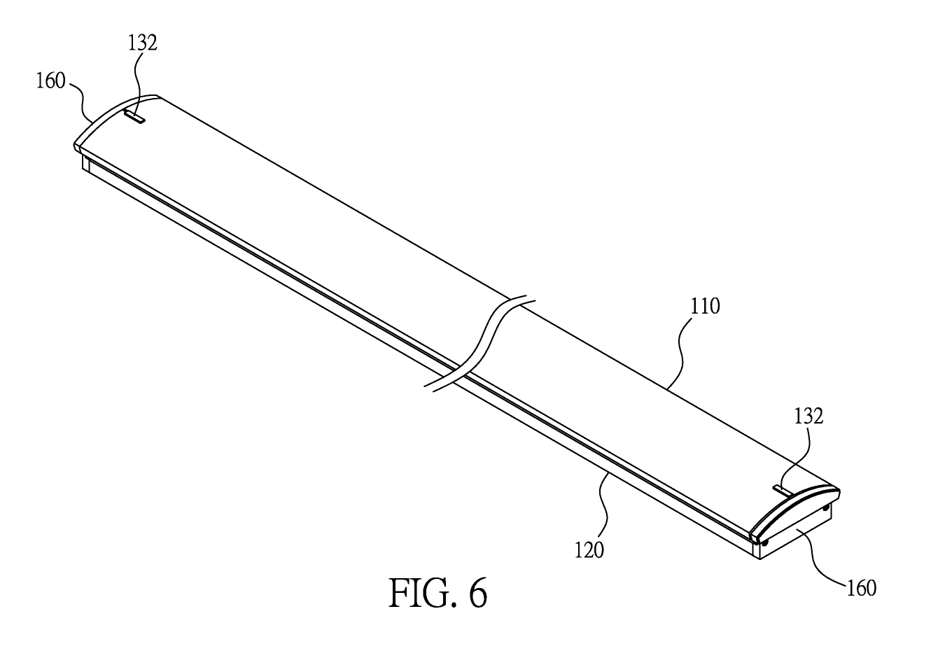

Referring to FIG. 5 and FIG. 6, wherein FIG. 5 is an exploded view illustrating the lamp tube with adjustable color temperature according to another preferred embodiment of the present invention; and FIG. 6 is a schematic view illustrating the assembly of the lamp tube with adjustable color temperature according to another preferred embodiment of the present invention.

As shown in figures, another preferred embodiment of the present invention discloses a lamp tube with adjustable color temperature, which includes: a top housing 110, a bottom housing 120, a slide device 130, a light source module 140, a light filtering module 150 and two end covers 160.

The top housing 110 is formed with a notch 111. Wherein, the top housing 110 is a transparent or translucent housing and made of, e.g. but not limited to, glass, acrylic or plastic.

The bottom housing 120 is disposed with a substrate 121. The bottom end of the substrate 121 is formed with a hollow chamber 122, two sides of substrate 121 are respectively formed with a first recess 123, the top end of each of the first recesses 123 is formed with a second recess 124, and the outer sides defined at two ends of the bottom housing 120 are respectively formed with a third recess 125 for being combined with the top housing 110. Wherein, the third recesses 125 are, e.g. but not limited to be, disposed at the outer bottom side of the substrate 121.

The slide device 130 includes a main body 131 and a sliding member 132. The sliding member 132 is exposed at the notch 111. Two ends of the main body 31 are respectively received in the second recesses 24, and the main body 31 is able to slide in the second recesses 24. Wherein, the slide device 130 is, e.g. but not limited to be, made of plastic. According to this embodiment, two slide devices 130 are adopted for illustration and respectively disposed at two ends of the top housing 110, what shall be addressed is that the scope of the present invention is not limited to the above-mentioned arrangement. If only one slide device 130 is adopted, the slide device 130 is disposed at one end of the top housing 110, and the objective of adjusting color temperature can also be achieved.

The light source module 140 is disposed on the substrate 121, and two ends thereof are respectively received in the first recesses 123. A plurality of LED chips 141 are disposed on the light source module 140. In addition, the light source module 140 further includes a printed circuit board 142, the printed circuit board 142 is used for carrying the plural LED chips 141. The printed circuit board 142 further includes a plurality of LED driving chips (not shown in figures), the plural LED driving chips are respectively coupled to the plural LED chips 141 for driving the plural LED chips 141. Wherein, the printed circuit board 142 is, e.g. but not limited to, an aluminum substrate or a copper substrate for enhancing the heat dissipation performance.

The light filtering module 150 is disposed on top of the light source module 140 and fastened at one side of the main body 131, e.g. but not limited to the left side. Two ends of the light filtering module 150 are respectively fastened in the second recesses 124. The light filtering module 150 is disposed with a plurality of light filtering sheets 151, and the quantity of the light filtering sheets 151 is preferably to be the same as the quantity of the LED chips 141. Wherein, the plural light filtering sheets 151 are formed with a, e.g. but not limited to, coating or printing means, and the shapes thereof are formed in a, e.g. but not limited to, circular or semi-circular shape; according to this embodiment, the circular shape is adopted for illustration, what shall be addressed is that the scope of the present invention is not limited to the above-mentioned arrangement.

The two end covers 160 are respectively covered at two ends of the top housing 110 and the bottom housing 120.

In addition, the lamp tube with adjustable color temperature provided by the present invention further includes a power module (not shown in figures) disposed in the hollow chamber 122, and one end thereof is coupled to the light source module 140 for supplying the electric power required by the light source module 140.

Moreover, the lamp tube with adjustable color temperature provided by the present invention further includes two wire clipping pieces 161. Each of the wire clipping pieces 161 is formed with two wire holes 162, respectively disposed at one side of the substrate 121 and capable of being fastened in the bottom housing 110. Two electric wires (not shown in figures) of the power module are able to pass the two wire holes 162 and respectively soldered on the light source module 140.

As shown in FIG. 6, when being assembled, the light source module 140 is inserted in the first recesses 123 from the outer side of the bottom housing 120; the light filtering module 150 is combined with the main body 131 of the slide device 130, and two sides of the light filtering module 150 and the main body 131 are inserted in the second recesses 124 from the outer side of the bottom housing 120; then the third recesses 125 are utilizing for enabling the top housing 110 to be engaged with the bottom housing 120, meanwhile the sliding member 132 is exposed at the notch 111 of the top housing 110, so the slide device 130 is able to slide in the second recesses 124; the two wire clipping pieces 161 are respectively fastened at one side of the substrate 121; lastly the two end covers 160 are respectively covered at two ends of the top housing 110 and the bottom housing 120. Accordingly, the assembly of the lamp tube with adjustable color temperature is assembled.

Based on what has been disclosed above, advantages achieved by the lamp tube with adjustable color temperature provided by the present invention are as followings: 1. a slide device and a light filtering module are installed, so when the slide device slides to a first location, the plural LED chips are enabled to emit lights with the first color temperature through the plural light filtering sheets, when the slide device slides to a second location, the plural LED chips are enabled to emit lights with the second color temperature, thereby achieving the objective of adjusting the color temperature of the lamp tube; and 2. a user can easily adjust the color temperature of the output lights. Accordingly, the lamp tube with adjustable color temperature and the lamp device provided by the present invention are novel and more practical in use comparing to prior arts.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A lamp tube with adjustable color temperature, including:
a top housing, formed in a hollow status, wherein the top end thereof is formed with a notch;
a bottom housing, disposed with a substrate, wherein the bottom end of said substrate is formed with a hollow chamber, two sides of said substrate and said bottom housing are respectively formed with a first recess, the top end of each of said first recesses is formed with a second recess, and the outer sides defined at two ends of said bottom housing are respectively formed with a third recess for being combined with said top housing;
a slide device, including a main body and a sliding member, wherein said sliding member is exposed at said notch, two ends of said main body are respectively received in said second recesses, and said main body is able to slide in said second recesses;
a light source module, disposed on said substrate and having two ends thereof received in said first recesses, wherein a plurality of LED chips are disposed on said light source module;
a light filtering module, disposed on top of said light source module, fastened at one side of said main body, and having two ends thereof fastened in said second recesses, wherein a plurality of light filtering sheets are disposed on said light filtering module; and
two end covers, respectively covered at two ends of said top housing and said bottom housing;
when said sliding member slides to a first location, said LED chips are enabled to emit lights with a first color temperature; and when said sliding member slides to a second location, said LED chips are enabled to emit lights with a second color temperature, thereby achieving an objective of adjusting the color temperature of said lamp tube.

2. The lamp tube with adjustable color temperature as claimed in claim 1, wherein said top housing is a transparent or translucent housing and made of glass, acrylic or plastic.

3. The lamp tube with adjustable color temperature as claimed in claim 1, wherein said bottom housing is an aluminum extruding member for enhancing the heat dissipation performance.

4. The lamp tube with adjustable color temperature as claimed in claim 1, wherein said light source module further includes a printed circuit board, said printed circuit board is used for carrying said LED chips, said printed circuit board further includes a plurality of LED driving chips, and said LED driving chips are respectively coupled to said LED chips for driving said LED chips.

5. The lamp tube with adjustable color temperature as claimed in claim 4, wherein said printed circuit board is an aluminum substrate or a copper substrate.

6. The lamp tube with adjustable color temperature as claimed in claim 1, wherein said light filtering sheet is formed with a coating or printing means.

7. The lamp tube with adjustable color temperature as claimed in claim 1, wherein the shape of said light filtering sheet is formed in a circular or semi-circular shape.

8. The lamp tube with adjustable color temperature as claimed in claim 1, further including a power module disposed in said hollow chamber, one end thereof is coupled to said end cover, and the other end thereof is coupled to said light source module for supplying the electric power required by said light source module.

9. The lamp tube with adjustable color temperature as claimed in claim 1, wherein when said sliding member slides to said first location, said light filtering sheets are respectively disposed on top of said LED chips, so said LED chips are enabled to emit lights with said first color temperature through said light filtering sheets; when said sliding member slides to said second location, said light filtering sheets are respectively disposed at one side of each of said LED chips, so said LED chips are enabled to emit lights with said second color temperature.

10. A lamp device with adjustable color temperature, including:
a top housing, having the top end formed with a notch;
a bottom housing, disposed with a substrate, wherein the bottom end of said substrate is formed with a hollow chamber, two sides of said substrate are respectively formed with a first recess, the top end of each of said first recesses is formed with a second recess, and the outer sides defined at two ends of said bottom housing are respectively formed with a third recess for being combined with said top housing;
a slide device, including a main body and a sliding member, wherein said sliding member is exposed at said notch, two ends of said main body are respectively received in said second recesses, and said main body is able to slide in said second recesses;
a light source module, disposed on said substrate and having two ends thereof received in said first recesses, wherein a plurality of LED chips are disposed on said light source module;
a light filtering module, disposed on top of said light source module, fastened at one side of said main body, and having two ends thereof fastened in said second recesses, wherein a plurality of light filtering sheets are disposed on said light filtering module; and
two end covers, respectively covered at two ends of said top housing and said bottom housing;
when said sliding member slides to a first location, said LED chips are enabled to emit lights with a first color temperature; and when said sliding member slides to a second location, said LED chips are enabled to emit lights with a second color temperature, thereby achieving an objective of adjusting the color temperature of said lamp device.

11. The lamp device with adjustable color temperature as claimed in claim 10, wherein said top housing is a transparent or translucent housing and made of glass, acrylic or plastic.

12. The lamp device with adjustable color temperature as claimed in claim 10, wherein said bottom housing is an aluminum extruding member for enhancing the heat dissipation performance.

13. The lamp device with adjustable color temperature as claimed in claim 10, wherein said light source module further includes a printed circuit board, said printed circuit board is used for carrying said LED chips, said printed circuit board further includes a plurality of LED driving chips, and said LED driving chips are respectively coupled to said LED chips for driving said LED chips, wherein said printed circuit board is an aluminum substrate or a copper substrate.

14. The lamp device with adjustable color temperature as claimed in claim 10, wherein said light filtering sheet is formed with a coating or printing means.

15. The lamp device with adjustable color temperature as claimed in claim 10, wherein the shape of said light filtering sheet is formed in a circular or semi-circular shape.

16. The lamp device with adjustable color temperature as claimed in claim 10, further including a power module disposed in said hollow chamber, one end thereof is coupled to said light source module for supplying the electric power required by said light source module.

17. The lamp device with adjustable color temperature as claimed in claim 16, further including two wire clipping pieces, each of said wire clipping pieces is formed with two wire holes, respectively disposed at one side of said substrate and capable of being fastened in said bottom housing, two electric wires of said power module are able to pass said two wire holes and respectively soldered on said light source module.

18. The lamp device with adjustable color temperature as claimed in claim 10, wherein when said sliding member slides to said first location, said light filtering sheets are respectively disposed on top of said LED chips, so said LED chips are enabled to emit lights with said first color temperature through said light filtering sheets; when said sliding member slides to said second location, said light filtering sheets are respectively disposed at one side of each of said LED chips, so said LED chips are enabled to emit lights with said second color temperature.
